(19) United States
(12) Patent Application Publication
(10) Pub. No.: US 2008/0247010 A1
(43) Pub. Date: Oct. 9, 2008

(54) Hologram Recording and Reproducing Apparatus and Hologram Recording Method

(75) Inventors: Masakazu Ogasawara, Saitama (JP); Yoshihisa Itoh, Saitama (JP); Yoshihisa Kubota, Saitama (JP)

Correspondence Address: SUGHRUE MION, PLLC, 2100 PENNSYLVANIA AVENUE, N.W., SUITE 800, WASHINGTON, DC, 20037, US

(73) Assignee: Pioneer Corporation, Meguro-ku, Tokyo (JP)

(21) Appl. No.: 11/908,828

(22) PCT Filed: Mar. 13, 2006
(86) PCT No.: PCT/JP2006/305319

§ 371 Date: Oct. 24, 2007

(30) Foreign Application Priority Data
Mar. 16, 2005 (JP) 2005-074748

(51) Int. Cl. G11B 7/0065; G03H 1/12

(52) U.S. Cl. 359/3; 359/11

(57) ABSTRACT

There is provided a hologram recording and reproducing apparatus for a hologram recording medium that stores optical interference fringes therein as a diffraction grating generated by coherent reference light and signal light. The hologram recording and reproducing apparatus includes a control circuit that is connected to a spatial light modulator and controls each pixel in such a way that the reference light is modulated according to information data to produce the signal light. The control circuit spatially classifies a plurality of pixels in the spatial light modulator into a central modulation area disposed on the optical axis and at least one annular modulation area sequentially disposed around the central modulation area in a concentric manner, and controls the pixels in the central modulation area and the pixels in the annular modulation area using respective different recording modulation methods to deliver the signal light through the central modulation area and the annular modulation area.

### TECHNICAL FIELD

The present invention relates to a hologram recording and reproducing apparatus that records information by applying signal light through a spatial light modulator onto a hologram recording medium (hereinafter simply referred to as a recording medium), a hologram reproducing apparatus that reproduces information from the recording medium, and a hologram recording method.

### BACKGROUND ART

For high-density information recording, the hologram technology has attracted attention because of its capability of high-density recording of two-dimensional data. Holograms are characterized in that wavefronts of light carrying information to be recorded are recorded as volumetric variation in refractive index on a recording medium made of a photosensitive material, such as photorefractive material.

For example, there is a known hologram recording apparatus that records data on a recording medium (see JP-A-2004-139021). FIG. 1 is a schematic view showing the hologram recording apparatus 400 according to JP-A-2004-139021. The hologram recording apparatus 400 includes a laser light source 10, a two-dimensional beam expander 420, a half-silvered mirror 30, a spatial modulation element 440, a mirror 450, a two-dimensional light receiving element 460, convex lenses 83 to 85, and a controller 490. The hologram recording apparatus 400 records and reproduces information to and from a hologram recording medium 7. The spatial modulation element 440 is a liquid crystal display element that has a plurality of pixels in the horizontal and vertical (two-dimensional) directions and modulates incident laser light in a two-dimensional manner. The mirror 450 is an optical element that reflects and redirects the laser light that has passed through the spatial modulation element 440. The controller 490 includes a data storage unit 91, a control amount adjuster 492, and a spatial modulator driver 493. The data storage unit 91 stores data to be recorded on the hologram recording medium 7. The control amount adjuster 492 adjusts the amount of control over pixels in the spatial modulation element 440 according to the positions of respective individual diffraction control elements 41, resulting in improvement in uniformity of the amount of signal light that reaches the hologram recording medium 7.

Although the diffraction efficiency of the laser light can be thus controlled to make the light intensity distribution uniform, it is typical to use a beam shaping element or the like to make the light intensity distribution uniform.

### DISCLOSURE OF THE INVENTION

Signal light modulated in a spatial modulation element, that is, a spatial light modulator, interferes with a coherent light beam that has not passed through the spatial light modulator, that is, reference light, on a recording medium. In this operation, information data is hologram-recorded on the recording medium as a hologram area (a diffraction grating of optical interference fringes).

According to the conventional hologram recording and reproducing apparatus, when the pixel size or pixel pitch in the spatial light modulator is reduced for higher density, the distance between the focused light position of the first-order diffracted light and that of the zero-order non-modulated light on the recording medium increases. It is therefore necessary to increase the area of the recording region on the recording medium to be irradiated with these diffracted light beams, or increase the cross-sectional areas of the spatial light modulator and the light path of the optical system and the like located on the exit side of the spatial light modulator. To record information on a recording region having a wider area, a high-intensity light source, such as a laser device having a tremendous power, is required. This will pose a problem from a viewpoint of manufacturing cost.

Accordingly, one of objects that the invention seeks to achieve is to provide a compact hologram recording and reproducing apparatus and a hologram recording method capable of tolerating non-uniformity of the light intensity distribution and improving the recording density and recording capacity.

The hologram recording and reproducing apparatus according to the invention is a hologram recording and reproducing apparatus for a hologram recording medium that stores optical interference fringes therein as a diffraction grating generated by coherent reference light and signal light. The hologram recording and reproducing apparatus includes

a light source that generates coherent reference light,

a spatial light modulator disposed on the optical axis of the reference light, the spatial light modulator having a plurality of pixels and using the plurality of pixels to modulate the reference light into signal light,

an interference section that applies the signal light and the reference light onto the hologram recording medium to form a hologram area therein using optical interference fringes generated by the signal light and the reference light, and

an image sensor that receives the reference light or reproduced light generated by the reference light and originating from the hologram area.

The hologram recording and reproducing apparatus is characterized in that the apparatus further includes a control circuit that is connected to the spatial light modulator and the image sensor and controls each of the pixels in such a way that the reference light is modulated according to information data to produce the signal light, and

the control circuit spatially classifies the plurality of pixels into a central modulation area disposed on the optical axis and at least one annular modulation area sequentially disposed around the central modulation area in a concentric manner, and controls the pixels in the central modulation area and the pixels in the annular modulation area using respective different recording modulation methods to deliver the signal light through the central modulation area and the annular modulation area.

The hologram recording method according to the invention is a hologram recording method used in a hologram recording and reproducing apparatus including a spatial light modulator disposed on the optical axis of coherent reference light, the spatial light modulator having a plurality of pixels and using the plurality of pixels to modulate the reference light into signal light, an interference section that applies the signal light and the reference light onto a hologram recording medium to form a hologram area therein using optical interference fringes generated by the signal light and the reference light, and an image sensor that receives the reference light or reproduced light generated by the reference light and originating from the hologram area, the hologram recording method being characterized in that the method includes the steps of:

measuring light intensity distribution by using the image sensor that receives the reference light or reproduced light generated by the reference light and originating from the hologram area;

based on the measured light intensity distribution, spatially classifying the plurality of pixels into a central modulation area disposed on the optical axis and at least one annular modulation area sequentially disposed around the central modulation area in a concentric manner; and

controlling the pixels in the central modulation area and the pixels in the annular modulation area using respective different recording modulation methods.

### BRIEF DESCRIPTION OF THE DRAWINGS

FIG. 1 is a schematic view showing a conventional hologram recording apparatus 400.

FIG. 2 is a graph showing the light intensity distribution of a light beam emitted from a laser light source.

FIG. 3 is a plan view of a spatial light modulator in a pickup of the hologram recording and reproducing apparatus according to the invention.

FIG. 4 is a plan view of an image sensor in the pickup of the hologram recording and reproducing apparatus according to the invention.

FIG. 5 is a graph showing the light intensity distribution of irradiation light on the line AA on the image sensor in FIG. 4.

FIG. 6 is a plan view of the spatial light modulator in the pickup of the hologram recording and reproducing apparatus according to the invention.

FIG. 7 is a plan view of the spatial light modulator in the pickup of the hologram recording and reproducing apparatus according to the invention.

FIG. 8 is a plan view of the image sensor in the pickup of the hologram recording and reproducing apparatus according to the invention.

FIG. 9 is a graph showing the normalized light intensity distribution of irradiation light on the line AA on the image sensor in FIG. 8.

FIG. 10 is a plan view of the spatial light modulator in the pickup of the hologram recording and reproducing apparatus according to the invention.

FIGS. 11 to 13 are diagrams for explaining the boundary between multilevel modulation areas in the spatial light modulator in the pickup of the hologram recording and reproducing apparatus according to the invention and the light intensity distribution of irradiation light.

FIG. 14 is a diagram for explaining the boundaries between multilevel modulation areas in the spatial light modulator in the pickup of the hologram recording and reproducing apparatus according to the invention.

FIG. 15 is a plan view of the spatial light modulator in the pickup of the hologram recording and reproducing apparatus of another embodiment according to the invention.

FIG. 16 a graph showing the light intensity distribution of irradiation light on the image sensor of the hologram recording and reproducing apparatus of the above other embodiment according to the invention.

FIGS. 17 to 19 each shows a plan view of the spatial light modulator in the pickup of the hologram recording and reproducing apparatus of another embodiment according to the invention.

FIG. 20 is a block diagram showing a schematic configuration of the hologram recording and reproducing apparatus according to the invention.

FIGS. 21 and 22 are configuration diagrams schematically showing the pickup of the hologram recording and reproducing apparatus according to the invention.

FIG. 23 is a plan view showing a photodetector in the pickup of the hologram recording and reproducing apparatus according to the invention.

FIG. 24 is a configuration diagram schematically showing the pickup of the hologram recording and reproducing apparatus according to the invention.

FIG. 25 is a flowchart showing the method for recording holograms according to the invention.

FIGS. 26 to 29 each shows a plan view of the image sensor in the pickup of the hologram recording and reproducing apparatus according to the invention.

FIG. 30 is a flowchart showing pattern matching in the hologram recording method according to the invention.

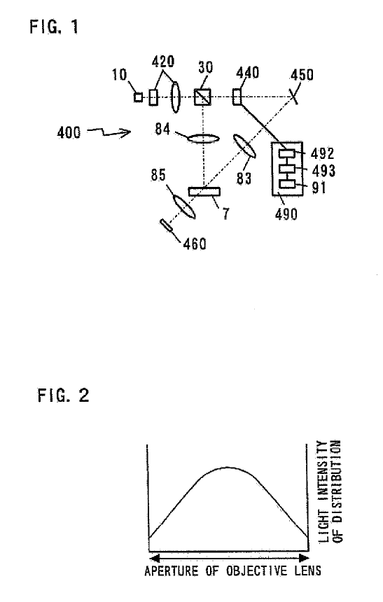

### DETAILED DESCRIPTION OF THE INVENTION

### [Principles]

Principles of the hologram recording and reproducing apparatus according to the invention will be described below with reference to the drawings.

The light emitted from a laser light source, such as a semiconductor laser, used in a hologram recording and reproducing apparatus is typically a Gaussian beam (see FIG. 2), and the peak of the light intensity distribution is situated at the center thereof, which is on the optical axis in the aperture (the effective light beam) of an objective lens for applying light onto a recording medium.

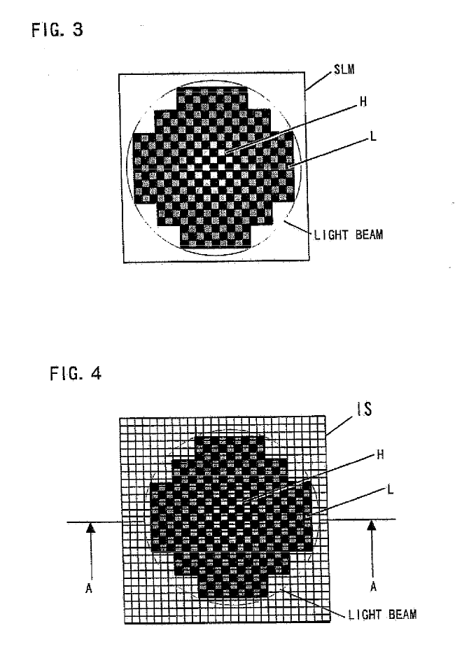

When such a Gaussian beam is incident on a spatial light modulator SLM that displays a checker pattern, the central part of the spatial light modulator SLM is irradiated brighter than the periphery (H>L), as shown in FIG. 3. Therefore, in the hologram recording and reproducing apparatus, the irradiated spatial light modulator SLM provides non-uniform illuminance. In the figure, information data supplied to the spatial light modulator SLM is shown two-dimensionally; a pixel that transmits incident light is expressed in white representing “1”, and a pixel that blocks incident light is expressed in black representing “0”. Such two-dimensional data is so-called page data, and the page data is, for example, expressed by a black-and-white checker pattern in FIG. 3.

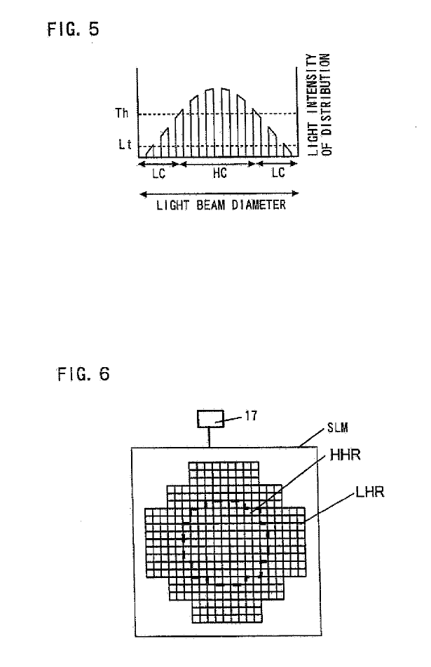

Thus, the beam that has passed through the spatial light modulator also exhibits non-uniformity in beam intensity (H>L) in an image obtained by focusing the beam that has passed through a Fourier transform optical system onto an image sensor IS located in a conjugate position, as shown in FIGS. 4 and 5.

Therefore, in hologram recording using the non-uniform intensity beam in a hologram recording and reproducing apparatus, a hologram recorded on a recording medium still suffers from the non-uniformity. In addition to this non-uniformity, reference light applied in a reproduction process is also non-uniform, so that a real image reconstructed by reproducing light (reproduced image on the image sensor IS) also provides non-uniform distribution similar to those shown in FIGS. 4 and 5. That is, in the central part of the reproduced checker pattern image, the difference between the white and black levels (i.e., contrast (the ratio of half the difference between white and black brightness (amplitude) to the average brightness, for example)) is sufficiently high so that high contrast HC is provided, while at the periphery, the contrast is not sufficiently high so that low contrast LC is provided. Conversely, when reference light is applied in such a way that the reproduced image has an optimum amount of light (optimum contrast) at the periphery of the image sensor IS, the amount of light in the central part of the image sensor IS may be excessive.

As described above, when the reference light is a Gaussian beam, reproduced light is bright, expressed in “white”, in the central part of the image sensor IS, while being dark, expressed in “black”, at the periphery. It is therefore conceivable to employ a beam shaping element or the like for making the beam intensity uniform to make the light intensity distribution uniform, but it is impossible to make it completely uniform. Furthermore, in an approach for making the light intensity distribution uniform, there is no choice but to reduce the high light intensity level to the low light intensity level in the light intensity distribution, resulting in poor light usage. This requires an extra optical element and hence prevents cost reduction.

The inventor proposes a hologram recording method for determining three or more-level modulation areas in the spatial light modulator according to the contrast distribution of an image obtained by reproduced light on the image sensor IS. In this method, multilevel modulation recording can be performed even when the beam intensity is non-uniform, allowing increase in hologram recording density. For example, in hologram recording, performing not only two-level spatial modulation recording that uses black and white levels but also intermediate grayscale modulation that uses a gray level for each pixel in the spatial light modulator allows multilevel (three-level) modulation recording that uses black, white, and gray levels. In this way, the recording density in a single hologram area can be increased. The threshold level that determines the boundary between the two-level modulation area and the three or more-level modulation area is approximately three times the lowest beam intensity Lt, where Lt is the lowest detected beam intensity of the reproduced image on the image sensor IS, for example as shown in FIG. 5. Therefore, setting the grayscale (level) of the outermost pixels in the m-level (m≧3) modulation area to Th=m×Lt allows multilevel modulation recording and reproducing in the recording and reproducing process. The threshold level and the outermost pixels in the modulation area can be stored in a memory or the like in a control circuit as a stored table in advance. By pre-identifying combinations of three or more-level modulation area patterns and information data experimentally, empirically, theoretically, mathematically, or by simulation, creating a stored table, for example, and storing it in a memory, reproduction using a hologram reproducing apparatus, which will be described later, can be performed more quickly and easily.

The spatial light modulator SLM is, for example as shown in FIG. 6, spatially classified into a central multilevel modulation area HHR, which is disposed on the optical axis and performs three or more-level light intensity modulation and transmissive or reflective spatial modulation on a coherent light beam, and one or more annular multilevel modulation areas LHR, which is sequentially disposed concentrically around the central multilevel modulation area and performs multilevel light intensity modulation, the number of levels being equal to or smaller than that in the central multilevel modulation area, and transmissive or reflective spatial modulation on a coherent light beam.

In the following embodiments, the spatial light modulator SLM does not uniformly perform two-level modulation on all pixels according to information data to be recorded, but defines three or more-level intensity modulation in the central multilevel modulation area, while performing two-level modulation, the number of levels being smaller than that in the central multilevel modulation area, outside the multilevel modulation area. That is, instead of performing two-level modulation across the area, but multilevel modulation is performed according to the light intensity distributions of reference light and signal light.

In the following embodiments, when a pixel is expressed in the unit of bits of information data, and for example, digital data is expressed by one pixel, the spatial light modulator SLM to be used is an apparatus that can express the light incident on the one pixel at least in three grayscales, “black”, “gray” and “white”, and spatially modulate a coherent light beam according to supplied multilevel information data. Therefore, in the following embodiments, the spatial light modulator SLM is preferably, for example, an active matrix TFT liquid crystal panel with a switching element corresponding to each pixel. For example, the spatial light modulator SLM is a transmissive liquid crystal device that applies a predetermined voltage to continuously change inclination of axes of liquid crystal molecules in such a way that the transmitted light intensity is modulated in an analog manner for analog grayscale display. In the following embodiments, multilevel recording can be performed, although partially, without using a special optical element, so that the hologram recording capacity can be increased in a simple way.

### FIRST EMBODIMENT

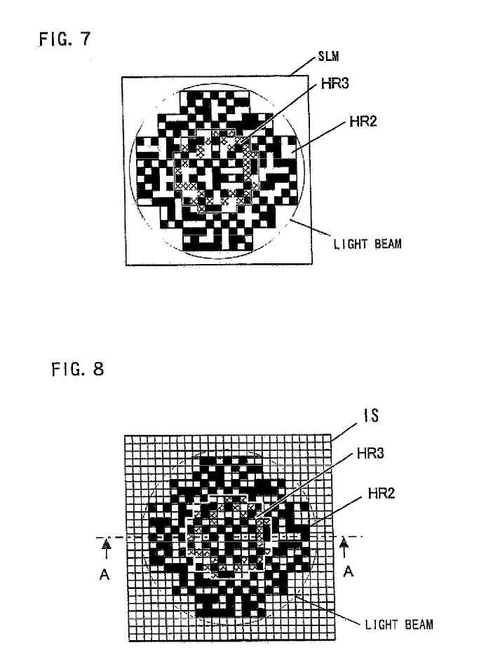

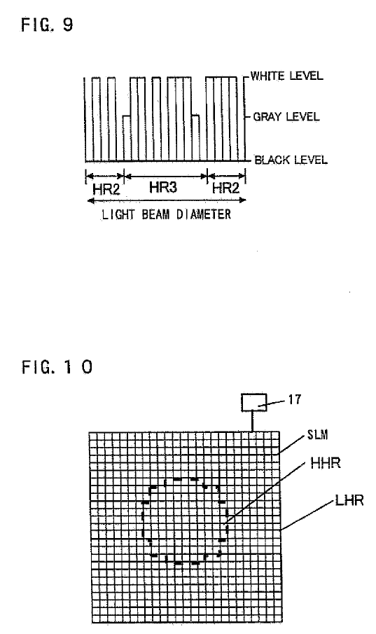

As shown in FIG. 7, the spatial light modulator SLM is spatially divided into two; a central three-level modulation area HR3 and a surrounding annular two-level modulation area HR2. Thus, as shown in FIGS. 8 and 9, in optically received data based on a reproduced image obtained by focusing the beam that has passed through a Fourier conversion optical system onto the image sensor IS located in a conjugate position, even a non-uniform beam that has passed through the spatial light modulator allows two-level recording (two grayscales of black and white levels) and three-level recording (three grayscales of black, white and gray levels). That is, high multilevel modulation recording is performed only in the multilevel modulation area in the spatial light modulator corresponding to the portion where the contrast of the reproduced image is high, while two-level modulation recording is performed in the modulation area in the spatial light modulator corresponding to the portion where the contrast is low, based on the contrast distribution of the reproduced image (on the image sensor IS) resulting from the intensity non-uniformity of the recording beam (the reference light and the signal light) and the non-uniformity of the recording medium.

In the multilevel modulation recording, three or more-level modulation is thus performed only in the multilevel modulation area where a high-contrast reproduced image is obtained in the spatial light modulator. The multilevel modulation area in the spatial light modulator is set in advance, and the multilevel modulation area in the spatial light modulator can be fixed by a recording medium and a pickup.

### SECOND EMBODIMENT

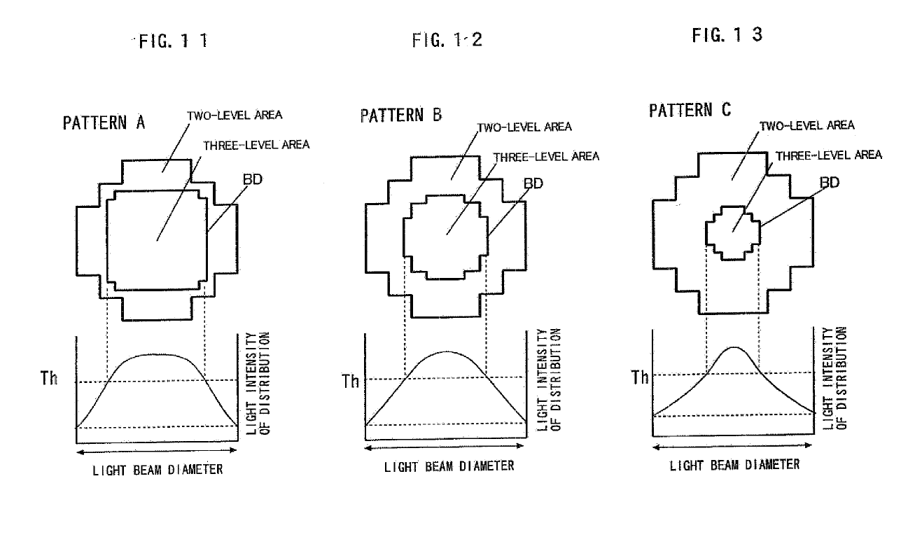

In addition to the first embodiment in which the multilevel modulation area in the spatial light modulator is fixed in advance, as shown in FIG. 10, the entire spatial light modulator SLM can be configured as a transmissive matrix liquid crystal device in such a way that a spatial light modulator drive circuit 17 displays an annular multilevel modulation area LHR and a central multilevel modulation area HHR therein. That is, the spatial light modulator SLM has a plurality of pixels arranged in a matrix. The control circuit connected to the spatial light modulator SLM spatially classifies the plurality of pixels in the spatial light modulator into the central multilevel modulation area disposed on the optical axis and the annular multilevel modulation area, and delivers signal light for each of the multilevel modulation areas.

The reproducing operation of the apparatus first begins with initial operation when a recording medium is loaded in the recording and reproducing apparatus. The control circuit acquires recording medium type data recorded in the reproduced image obtained from the annular area, uses a stored table to set the boundary of the multilevel modulation area in the spatial light modulator based on the type data, and compares the thus set multilevel modulation area with the light intensity distribution detected by the image sensor for reproduction.

### THIRD EMBODIMENT

The spatial light modulator shown in FIG. 10 may also be configured in such a way that the control circuit controls the spatial light modulator to define the boundary between the central and annular multilevel modulation areas based on the light intensity distribution detected by the image sensor IS that receives reference light or reproduced light from the hologram area produced by reference light.

That is, when the contrast distribution of the reproduced image on the image sensor IS is unknown, a test pattern is recorded and reproduced to acquire the contrast distribution, which allows determination of (the boundary of) the multilevel modulation area in the spatial light modulator SLM. The boundary of the multilevel modulation area in the spatial light modulator is determined by a preset contrast threshold value.

For example, when the contrast distribution varies depending on various recording media, a test pattern is recorded to acquire the contrast distribution. The contrast distribution of the reproduced image is obtained by recording a test pattern containing all modulation areas on a recording medium and then reproducing the hologram. For example, the test pattern is a checker pattern modulated using two levels (black and white). The difference in brightness between the black and white levels in the reproduced test pattern image on the image sensor IS is measured to obtain the contrast distribution. Based on a predetermined contrast threshold value, the boundary between multilevel modulation areas in the spatial light modulator, for example, a first boundary between the two-level and three-level areas, is determined.

For example, as shown in FIGS. 11, 12 and 13, the first boundary BD between the multilevel modulation areas in the spatial light modulator can be set to any one of patterns A, B and C according to the shape of the contrast distribution shown in the lower part of the figures; a broad one, a medium one and a narrow one.

### FOURTH EMBODIMENT

When a hologram in which a test pattern is recorded is reproduced, the reproduced image is focused on the image sensor IS. If the contrast of the reproduced image is sufficient in the central multilevel modulation area HHR where the light intensity is modulated using three or more levels, multilevel modulation can be performed by setting a plurality of threshold values (multilevel modulation area). That is, it is also possible to further divide the multilevel modulation area HHR in the spatial light modulator SLM into sub-areas and change the grayscale (the amount of multilevel modulation) according to the contrast ratio for each sub-area (the ratio of the highest brightness to the lowest brightness for each sub-area).

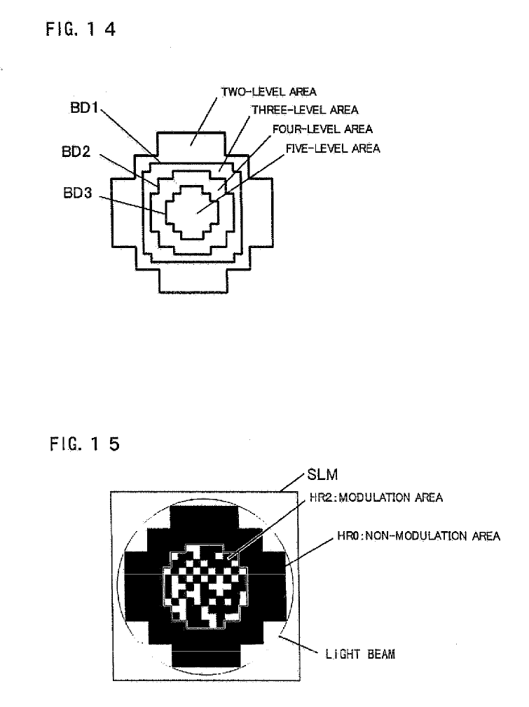

For example, as shown in FIG. 14, it is also possible to set first, second and third boundaries BD1, BD2 and BD3 to provide multilevel modulation areas; a two-level area, a three-level area, a four-level area, and a five-level area arranged from the periphery to the center of the spatial light modulator SLM.

The control circuit thus controls the spatial light modulator in such a way that light intensity modulation is performed in each of the annular multilevel modulation areas sequentially disposed from the central multilevel modulation area, using three or more levels for the central multilevel modulation area and decremented grayscales for the following annular multilevel modulation areas.

### FIFTH EMBODIMENT

When the contrast distribution of the reproduced image on the image sensor IS is unknown, multilevel modulation areas in the spatial light modulator can be determined by application of only reference light and resultant reflection. For example, when a highly transparent, optically isotropic recording medium or the like has no factor causing contrast distribution in a reproduced image, instead of loading the recording medium in the apparatus, it is possible to use a method for measuring the contrast distribution of the irradiation beam obtained by preparing a reference reflective surface and using the spatial light modulator SLM to apply full-white and full-black patterns. Multilevel modulation areas in the spatial light modulator are determined by a preset threshold value for the contrast distribution.

The measurement method performed by applying full-white and full-black patterns is known as a so-called full-on/off contrast ratio obtained by alternately applying full-white and full-black screens irradiated with reference light onto the image sensor and calculating the ratio between their brightness. It is also possible to evenly divide the image sensor IS as appropriate into zones, apply the full-white pattern, measure the central light intensity in each zone, apply the full-black pattern, measure the central light intensity in each zone, and calculate the ratio between average zone intensities to measure the contrast distribution.

### SIXTH EMBODIMENT

In an embodiment in which no multilevel recording area is determined in advance, information that defines a determined multilevel recording area must be stored after recording the hologram. Examples of a method for storing such information include recording it in part of the recording medium (such as the two-level area), an IC tag of a media cartridge, and a RAM in a disk drive. Alternatively, a multilevel modulation area may be determined by selecting the closest one from several prepared area pattern models. In this case, for example, a character or the like corresponding to the pattern may only need to be stored.

### SEVENTH EMBODIMENT

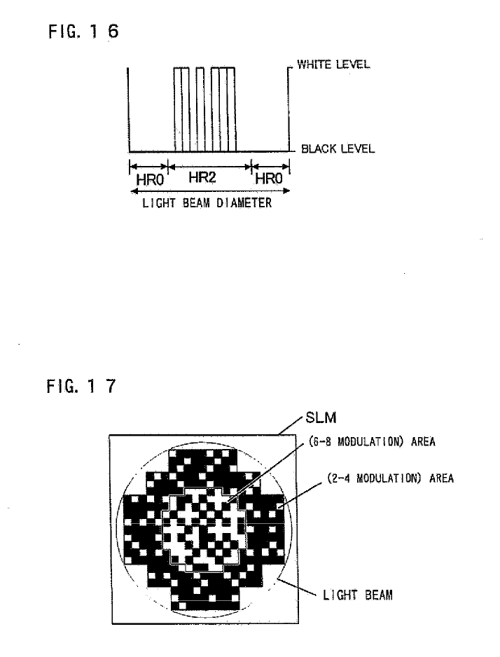

Furthermore, after the light intensity distribution (contrast distribution) is measured in a similar manner to the fourth and fifth embodiments, it is also possible to change the recording aspect based on the light intensity distribution. As shown in FIG. 15, the spatial light modulator drive circuit 17 can configure the entire spatial light modulator SLM to display an annular non-modulation area HR0 (light blocking area) and a central two-level modulation area HR2 therein. That is, as shown in FIG. 16 illustrating the normalized light intensity distribution of irradiation light on the image sensor, unlike the seventh embodiment, recording is not carried out in the outer area where the contrast is low, but only in the inner central modulation area HR2 where high S/N is expected. In the recording operation of the apparatus, recording is carried out only in an area where contrast is high enough.

The reproducing operation of the apparatus first begins with initial operation when a recording medium is loaded in the recording and reproducing apparatus. The control circuit acquires recording medium type data recorded in the reproduced image obtained from the annular area, uses a stored table to set the boundary of the modulation area in the spatial light modulator based on the type data, and compares the thus set modulation area with the light intensity distribution detected by the image sensor for reproduction.

### Eighth Embodiment

It is possible to employ a configuration in which after a test pattern is recorded, for example, and an area where contrast is high enough is checked as in the seventh embodiment, a recording area (the boundary between the central modulation area where the optical axis passes and the surrounding annular modulation area) is determined, and the control circuit can determine a recording modulation method for each of the modulation areas based on the measured light intensity distribution.

Depending on the light intensity of the light intensity distribution the recording modulation method is changed, for example, to the one effective in a low S/N area because the readout S/N likely decreases in the outer area where contrast is low. For example, as shown in FIG. 17, a recording modulation method with a large black area is employed in the peripheral annular modulation area (low-contrast area), while a modulation method with a small black area is employed in the central modulation area (high-contrast area). For example, a 2-4 modulation method (by using four pixels to express two-bit data, a group of patterns, in each of which one of the four pixels is bright while the others are dark, can be used to record all two-bit data) can be employed in the annular modulation area, while a 6-8 modulation method (by using eight pixels to express six-bit data, a group of patterns, in each of which four of the eight pixels are bright while the others are dark, can be used to record all six-bit data) can be employed in the central modulation area.

Based on the measured light intensity distribution, the control circuit controls each pixel in the central modulation area and the annular modulation area using a light intensity modulation method in which the amount of light that the image sensor receives increases as the pixel is closer to the inner side or farther from the outer side. This method ensures enough readout S/N in the low-contrast area.

### NINTH EMBODIMENT

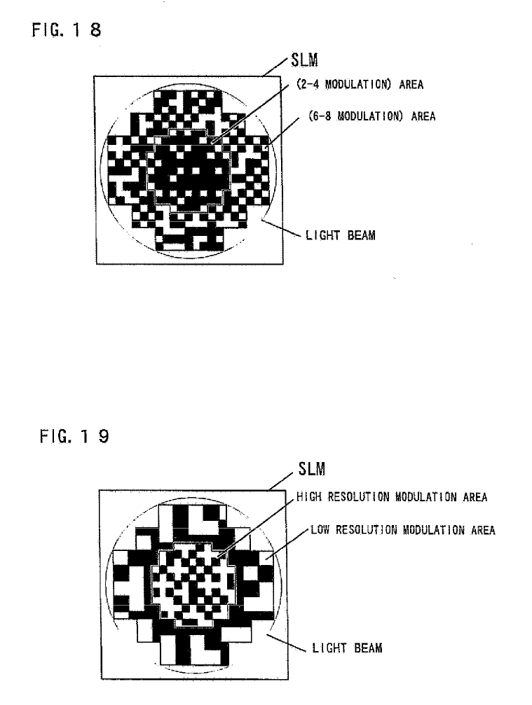

In contrast to the eighth embodiment, considering the fact that the amount of light for recording decreases in the outer area where contrast is low, it is also possible to change the modulation method to the one with a large white area. For example, as shown in FIG. 18, a recording modulation method with a large white area, for example, the 6-8 modulation method, can be used in the peripheral annular modulation area (low-contrast area), while the 2-4 modulation method with a small white area can be used in the central modulation area (high-contrast area).

Based on the measured light intensity distribution, the control circuit controls each pixel in the central modulation area and the annular modulation area using a light intensity modulation method in which the amount of light that the image sensor receives decreases as the pixel is closer to the inner side or farther from the outer side. This method can make the light intensity of the signal light on the image sensor uniform.

### TENTH EMBODIMENT

In a configuration in which the control circuit determines the recording modulation method for each modulation area based on the light intensity distribution obtained after the measurement of the light intensity distribution (contrast distribution), a recorded minimum pixel size may be changed according to the magnitude of the light intensity distribution.

As shown in FIG. 19, since the readout S/N likely decreases in the outer area where contrast is low, a minimum modulation unit to be driven is enlarged in such an area. For example, as shown in FIG. 19, a recording modulation method in which modulation is performed at a low resolution is used in the peripheral annular modulation area (low-contrast area), while a modulation method in which modulation is performed at a high resolution is used in the central modulation area (high-contrast area). That is, based on the measured light intensity distribution, the control circuit controls each pixel in the central modulation area and the annular modulation area using a light intensity modulation method in which the resolution of the pattern formed of the pixel increases as the pixel is closer to the inner side or farther from the outer side. Although this method reduces the resolution of the pattern in the inner-to-outer direction and hence reduces the recording density, the readout performance can be improved.

### Eleventh Embodiment

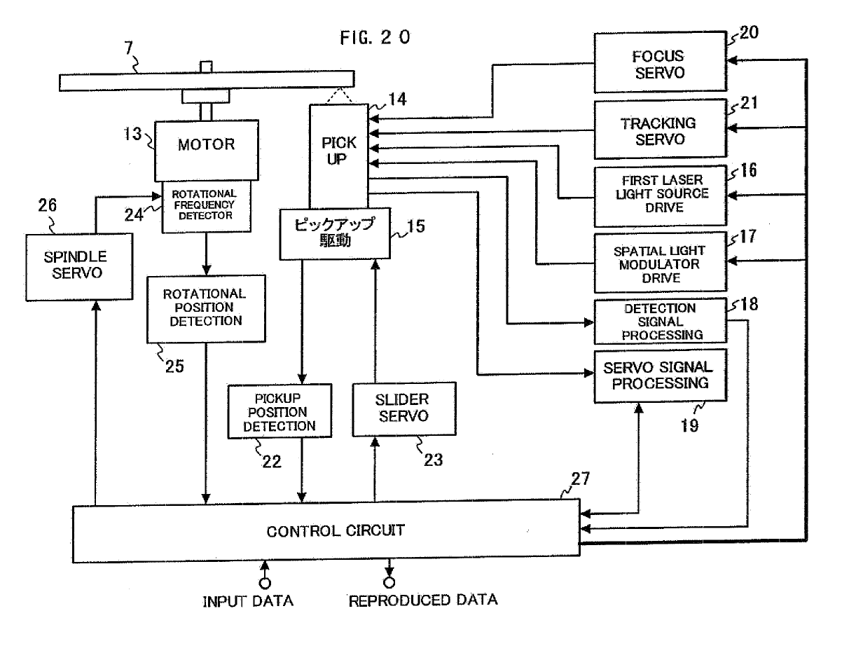

FIG. 20 shows an exemplary schematic configuration of the hologram recording and reproducing apparatus that records information on a hologram disk according to the invention. The hologram recording and reproducing apparatus includes a spindle motor 13 that rotates a hologram disk 7 via a turntable, a pickup 14 that reads a signal from the hologram disk 7 via a light beam, a pickup driver 15 that holds the pickup and moves it in the disk radial direction, a first laser light source drive circuit 16, a spatial light modulator drive circuit 17, a detection signal processing circuit 18, a servo signal processing circuit 19, a focus servo circuit 20, a tracking servo circuit 21, a pickup position detection circuit 22 that is connected to the pickup driver 15 and detects a pickup position signal, a slider servo circuit 23 that is connected to the pickup driver 15 and supplies a predetermined signal thereto, a rotational frequency detector 24 that is connected to the spindle motor 13 and detects a spindle motor rotational frequency signal, a rotational position detection circuit 25 that is connected to the rotational frequency detector and generates a rotational position signal of the hologram disk 7, a spindle servo circuit 26 that is connected to the spindle motor 13 and supplies a predetermined signal thereto, and a control circuit 27 that is connected to the spindle servo circuit 26. The control circuit 27 performs, for example, focusing (Z direction) and tracking (X and Y directions) servo control over the pickup through these drive circuits based on signals from these circuits. The control circuit 27 is formed of a microcomputer on which various memories are mounted and controls the entire apparatus. The control circuit 27 generates various control signals according to inputs from an operation section operated (not shown) by a user and current operating conditions of the apparatus. The control circuit 27 is also connected to a display section (not shown) that displays operating conditions and the like to the user. The control circuit 27 also encodes data to be recorded that is inputted from outside and supplies a predetermined signal to the spatial light modulator drive circuit 17 to control recording operation.

The control circuit 27 stores the relationship between three or more-level modulation area patterns and values of information data modulated by pixels in a memory as a stored table. Then, the information data is read by identifying the three or more-level modulation area pattern of the received, reproduced light, and referring to the stored table to identify information data corresponding to the identified three or more-level modulation area pattern.

Based on the data from the reproduced image received by the image sensor IS, the control circuit 27 identifies recorded pixels superimposed on the hologram area and identifies the contents of the information data recorded for each of the pixels (that is, two-level data value or three or more-level data value), for example, by referring to the stored table described above. The information data recorded on the hologram disk 7 in the high-density recording process described above are thus reproduced. Such a procedure allows an increased recording density, an increased recording capacity, and reduction in size and weight of the entire apparatus.

Furthermore, the control circuit 27 controls the spatial light modulator drive circuit 17 by correcting optical position deviation between the objective lens provided in the pickup 14 and the multilevel modulation area to which recorded data of the spatial light modulator is supplied, based on a signal from the image sensor IS provided in the pickup or a signal from the detection signal processing circuit 18 connected to an objective lens detector that measures the amount of displacement of the objective lens.

The hologram disk 7 held on the turntable on the light exit side of the objective lens is a disk-shaped recording medium. The hologram disk 7 includes a reflective layer, a separation layer, a recording layer, and a protective layer stacked on a substrate, and the protective layer faces the objective lens. The substrate is made of, for example, glass or plastic material. The reflective layer is formed of, for example, a multilayer film made of metal, such as aluminum, or dielectric. The reflective layer functions as a guide layer and includes a guide track to carry out servo control including at least tracking servo. Examples of the material of the recording layer include photosensitive materials capable of storing optical interference fringes, such as photorefractive material, hole burning material and photochromic material. Holograms are recorded in the recording layer above the guide track. The separation layer and the protective layer are made of light transmitting material and function to planarize the stack structure and protect the recording layer and the like.

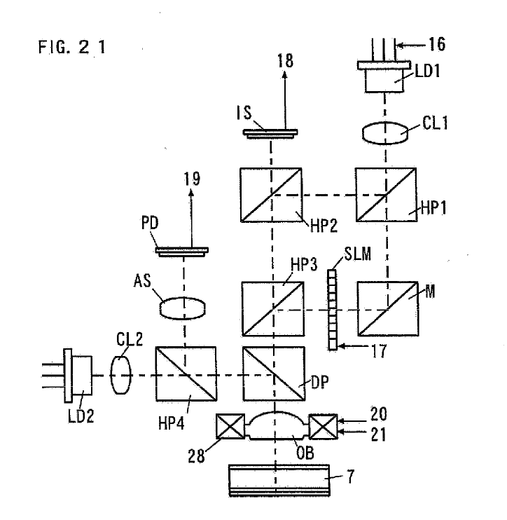

FIG. 21 shows an exemplary configuration of the pickup of the hologram recording and reproducing apparatus.

The pickup includes a recording optical system including a first laser light source LD1 for recording holograms, a first collimator lens CL1, a first half-silvered mirror HP1, a mirror M, the spatial light modulator SLM, the image sensor IS, a second half-silvered mirror HP2, and a third half-silvered mirror HP3; a servo system in a servo signal detector for carrying out servo control (focusing and tracking) on the light beam position relative to the hologram disk 7, the servo system including a second laser light source LD2, a second collimator lens CL2, a fourth half-silvered mirror HP4, an astigmatism element AS, such as a cylindrical lens, and a photodetector PD; and a common system including a dichroic prism DP and the objective lens OB. These systems except the objective lens OB are disposed in a substantially common flat plane. The half-silvered mirror surfaces of the first, second and third half-silvered mirrors HP1, HP2 and HP3 and the reflective surface of the mirror M are disposed parallel to each other, and the separation surface of the dichroic prism DP and the half-silvered mirror surface of the fourth half-silvered mirror HP4 are disposed parallel to each other and to the direction of a normal to the half-silvered mirror surfaces of the first, second and third half-silvered mirrors HP1, HP2 and HP3 and the reflective surface of the mirror M. These optical components are disposed in such a way that the optical axes (dashed lines) of the light beams from the first and second laser light sources LD1 and LD2 extend along the recording optical system and the servo system, respectively, and substantially merge into one in the common system.

The pickup 14 further includes an objective lens driver 28 including a focusing unit that moves the objective lens OB in the optical axis direction and a tracking unit that moves the objective lens OB in the disk radial direction perpendicular to the optical axis (and in the direction perpendicular thereto). The beam diameters of signal light and reference light are greater than the space through which incident light applied onto the objective lens can be transmitted and focused into a spot, that is, the aperture area of the objective lens (the effective diameter of the lens), and the range within which the aperture area moves as the objective lens moves is set within the beam diameters of the signal light and the reference light.

The first laser light source LD1 is connected to the first laser light source drive circuit 16, which adjusts the output of the first laser light source LD1 in such a way that the intensity of the exit light beam is reduced at the time of multilevel modulation area positioning while increased at the time of recording.

The spatial light modulator SLM is, for example, a liquid crystal panel having a plurality of pixel electrodes divided in a matrix, and has a capability of electrically controlling transmission of incident light in an analog manner. The spatial light modulator SLM is connected to the spatial light modulator drive circuit 17, modulates the light beam and generates signal light in such a way that the components of the signal light are distributed based on information data from the spatial light modulator drive circuit 17.

The image sensor IS is formed of a photodiode array, a CCD (Charge Coupled Device), a complementary metal oxide semiconductor device (CMOS) array or the like having a plurality of light receiving elements arranged in a matrix. The image sensor IS receives signal light from a recording medium, which will be described later, and converts the signal light into an electric signal. The image sensor IS is connected to the detection signal processing circuit 18. The detection signal processing circuit 18 processes the optically received signal from the image sensor IS and supplies the control circuit 27 with a positional deviation signal corresponding to the amount of optical positional deviation between the objective lens OB and the multilevel modulation area in the spatial light modulator SLM.

In the detection of the signal light image in the above description, a pixel in the spatial light modulator has a one-to-one relationship with a light receiving element in the image sensor IS, but a plurality of light receiving elements may detect unit data of page data (pixels in the spatial light modulator). For example, when the spatial light modulator has 800×800 pixels, the image sensor IS may have 1600×1600 pixels, i.e., light receiving elements.

The photodetector PD for servo control is connected to the servo signal processing circuit 19, and formed of divided light receiving elements for the focusing and tracking servo typically used in optical disks. Applicable examples of the servo method include an astigmatism method and a push-pull method. Output signals from the photodetector PD, such as a focus error signal and a tracking error signal, are supplied to the servo signal processing circuit 19.

The servo signal processing circuit 19 uses the focus error signal to generate a focusing drive signal, which is supplied to the focus servo circuit 20 via the control circuit 27. The focus servo circuit 20 drives the focusing unit in the objective lens driver 28 built in the pickup 14 according to the drive signal, and the focusing unit adjusts the focused position of the light spot applied on the hologram disk.

Furthermore, the servo signal processing circuit 19 uses the tracking error signal to generate a tracking drive signal, which is supplied to the tracking servo circuit 21. The tracking servo circuit 21 drives the tracking unit in the objective lens driver 28 built in the pickup 14 according to the tracking drive signal, and the tracking unit shifts the position of the light spot applied on the hologram disk in the disk radial direction or in the track direction by the amount corresponding to the drive current generated from the tracking drive signal.

The control circuit 27 generates a slider drive signal based on the position signal from the operation section or the pickup position detection circuit 22 and the tracking error signal from the servo signal processing circuit 19, and supplies it to the slider servo circuit 23. The slider servo circuit 23 moves the pickup 14 via the pickup driver 15 in the disk radial direction according to the drive current generated from the slider drive signal.

The rotational frequency detector 24 detects a frequency signal indicative of the current rotational frequency of the spindle motor 13 that rotates the hologram disk 7 via the turntable, generates a rotational frequency signal indicative of the spindle rotational frequency corresponding to the frequency signal, and supplies the rotational frequency signal to the rotational position detection circuit 25. The rotational position detection circuit 25 generates a rotational frequency position signal and supplies it to the control circuit 27. The control circuit 27 generates a spindle drive signal, supplies it to the spindle servo circuit 26, and controls the spindle motor 13 to rotate the hologram disk 7.

The operation of the hologram recording and reproducing apparatus will now be described.

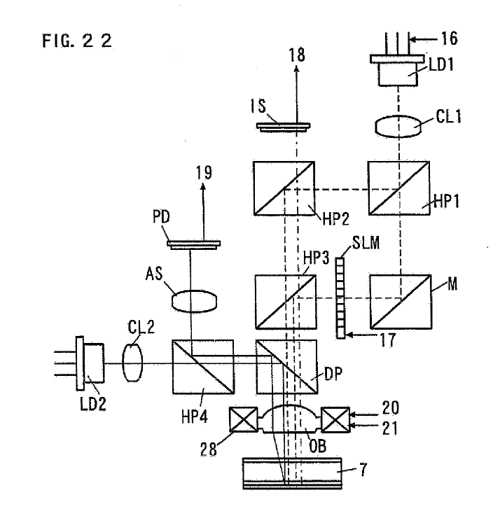

As shown in FIG. 22, the second laser light source LD2 for servo control emits coherent light having a wavelength different from that of the first laser light source LD1. The servo light beam from the second laser light source LD2 (indicated by a thin solid line displaced from the optical axis for the sake of explanation of the light path) is guided through the servo detection light path formed of the second collimator lens CL2 and the fourth half-silvered mirror HP4, and enters the dichroic prism DP. The servo light beam is reflected off the dichroic prism DP, focused by the objective lens OB and then incident on the hologram disk 7. The servo light beam that is reflected off the hologram disk 7 and returns through the objective lens OB is reflected off the fourth half-silvered mirror HP4, passes through the astigmatism element AS, and is incident along a normal to the light receiving surface of the photodetector PD for servo control.

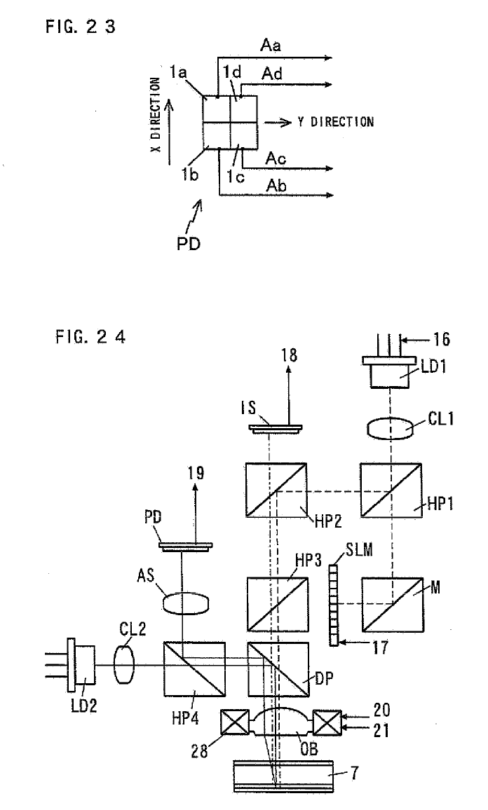

Such a servo light beam is used to carry out positioning servo control relative to the hologram disk 7. When an astigmatism method is used, the photodetector PD is formed of light receiving elements 1a to 1d having quadrisected light beam receiving surfaces, for example, as shown in FIG. 23. The directions of the quadrisecting lines correspond to the disk radial (X) direction and the track tangential (Y) direction. The photodetector PD is designed in such a way that the focused light spot forms a circle having its center at the intersection of the quadrisecting lines of the light receiving elements 1a to 1d.

The servo signal processing circuit 19 generates an RF signal Rf and a focus error signal according to the output signals from the light receiving elements 1a to 1d of the photodetector PD. Now let Aa to Ad be the output signals from the light receiving elements 1a to 1d in this order. The RF signal Rf is calculated by Aa+Ab+Ac+Ad. The focus error signal FE is calculated by (Aa+Ac)−(Ab+Ad). The tracking error signal TE is calculated by (Aa+Ad)−(Ab+Ac). These error signals are supplied to the control circuit 27.

In the above embodiment, although the astigmatism method and the push-pull method are used to carry out the focusing servo and the tracking servo, the methods to be used are not limited thereto, but may be other known methods, such as a three-beam method.

After the servo control is completed, as shown in FIG. 22, the first laser light source LD1 emits coherent light having a light intensity lower than the intensity at which the recording medium is sensitive and recordable. The first half-silvered mirror HP1 divides this coherent light into reference light and light to be modulated. (The two beams are indicated by broken lines displaced from the optical axis for the sake of explanation of the light path.)

The light to be modulated is reflected off the mirror M and incident along a normal to the principal plane of the spatial light modulator SLM. The spatial light modulator SLM partially transmits the incident light to be modulated to spatially modulate it. The modulated signal light is then directed to the third half-silvered mirror HP3.

The reference light is reflected off the second half-silvered mirror HP2 and directed to the third half-silvered mirror HP3.

The reference light and the signal light merge in the third half-silvered mirror HP3. After merged, the two light beams pass through the dichroic prism DP, are focused by the objective lens OB onto the hologram disk 7, and interfere with each other. In this case, the interference is not recorded as a hologram in the recording layer of the hologram disk 7 because the coherent light from the first laser light source LD1 is low in intensity.

The signal light reflected off the reflective layer of the hologram disk 7 (indicated by a dashed line displaced from the optical axis for the sake of explanation of the light path) enters the objective lens, passes through the dichroic prism DP, the third half-silvered mirror HP3 and the second half-silvered mirror HP2, and is incident on the image sensor IS. The image sensor IS converts the received light into an electric signal, and supplies the electric signal to the detection signal processing circuit 18. The detection signal processing circuit 18 uses the electric signal to generate a positional deviation signal corresponding to the amount of positional deviation between the aperture area of the objective lens (the effective diameter of the lens) and the multilevel modulation area, and supplies the positional deviation signal to the control circuit 27. The control circuit 27 processes the positional deviation signal to determine the amount of positional deviation between the position of the multilevel modulation area and the position of the aperture area of the objective lens in units of pixels in the spatial light modulator, and determines where to set the multilevel modulation area for information data supplied to the spatial light modulator drive circuit 17 according to the amount of positional deviation.

The spatial light modulator drive circuit 17 receives the information data corrected in the control circuit 27 and supplies it to the spatial light modulator SLM. After the positioning of the multilevel modulation area is completed, the output from the first laser light source LD1 is increased to the intensity at which the recording layer of the hologram disk is sensitive enough, and the hologram formed in the recorded layer is recorded.

The pickup can be used to reproduce the hologram from the recording medium. During reproduction, as shown in FIG. 24, although the first half-silvered mirror HP1 divides the coherent light from the first laser light source LD1 into reference light and signal light as in recording, only the reference light is used to reproduce the hologram. The spatial light modulator SLM is set to block light, so that only the reference light, which exits the first half-silvered mirror HP1, enters the second half-silvered mirror HP2 and is reflected off the second half-silvered mirror HP2, passes through the dichroic prism DP and the objective lens OB and is incident on the hologram disk 7.

The reproduced light (double-dashed line) generated in the hologram disk 7 passes through the objective lens OB, the dichroic prism DP, the third half-silvered mirror HP3, and the second half-silvered mirror HP2, and is incident on the image sensor IS. The image sensor IS sends the output corresponding to the image obtained by focusing the reproduced light to the detection signal processing circuit 18, where a reproduced signal is generated and supplied to the control circuit 27 to reproduce the recorded data. It is noted that during reproduction of a hologram, as in recording, the servo light beam is used to carry out the positioning servo control relative to the hologram disk 7.

In the exemplary configuration of the pickup described above, although the light beam from the first laser light source LD1 is incident on the spatial light modulator SLM via the first collimator lens CL1, the first half-silvered mirror HP1, and the mirror M, the light path is not limited thereto. For example, the spatial light modulator SLM may be disposed between the first half-silvered mirror HP1 and the mirror M, instead of between the mirror M and the third half-silvered mirror HP3.

In the above embodiment, although the description has been made using a transmissive spatial light modulator, but the spatial light modulator is not limited thereto. For example, a reflective spatial light modulator may be used. That is, the modulation method in the spatial light modulator is not limited to the method depending on whether or not the incident light is transmitted. For example, a method depending on whether or not the incident light is reflected or a method in which the polarization plane of the incident light is changed may be used.

In the hologram recording and reproducing apparatus described above, although the positioning based on optical positional deviation between the aperture area of the objective lens and the multilevel modulation area is carried out by changing where to set the multilevel modulation area in the spatial light modulator, the positioning method is not limited thereto. For example, the amount of movement from the reference position of the objective lens may be directly measured by measurement means, such as an optical sensor.

### [Method for Recording Holograms]

The method for recording and reproducing holograms according to the invention will be described below.

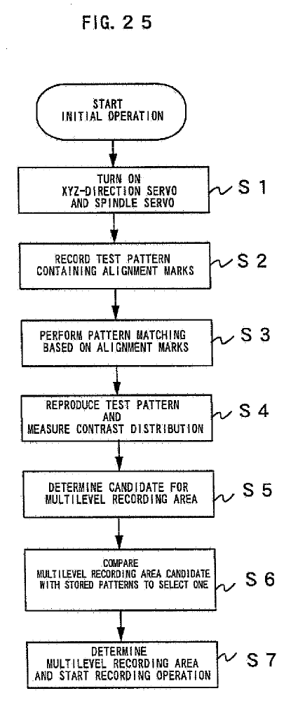

When n×n light receiving elements are used to detect unit data in the image sensor, for example, a hologram is recorded by following the flowchart shown in FIG. 25.

First, after a recording medium is loaded in the apparatus and the recording operation is started, the XYZ-direction servo and spindle servo are activated to move the focal point of the objective lens to a predetermined position on the recording medium (step S1).

Then, information data containing a test pattern to be recorded containing positioning marks is supplied to the spatial light modulator. The output of the laser light is increased, and the signal light and the reference light are applied to the recording medium to record a hologram (step S2).

Next, the test pattern is reproduced from the recording medium, and the positioning marks are used to perform pattern matching on the image sensor IS (step S3).

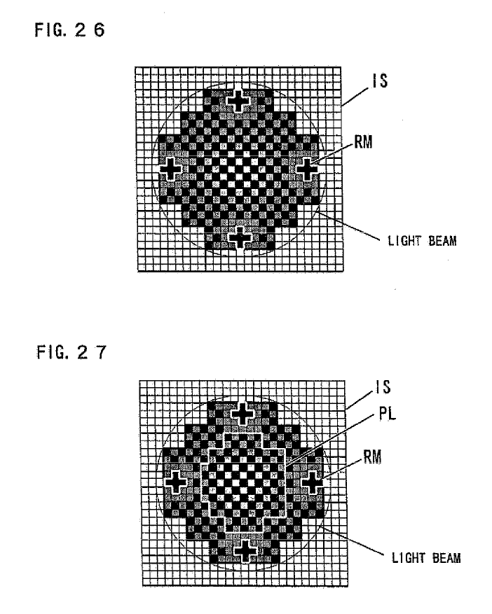

Then, the contrast distribution is measured with reference to the positioning marks (step S4). The measurement is carried out, for example, by irradiating the test pattern containing positioning marks. From the data from the image sensor IS, the control circuit calculates the highest beam intensity value Ht, the lowest beam intensity value Lt, the threshold level m×Lt (m≧3) and the like. It is noted that the test pattern containing positioning marks may be a two-level (black and white) modulated checker pattern with cross characters (RMs) arranged on the four edges of a rectangle having the size that is inscribed in the aperture area LA of the lens, for example as shown in FIG. 26.

Next, a candidate for the multilevel recording area is determined based on the contrast distribution (step S5). For example, as shown in FIG. 27, the control circuit recognizes a contour line PL that defines a candidate for the multilevel recording area based on the threshold level, and the data is then stored in a memory.

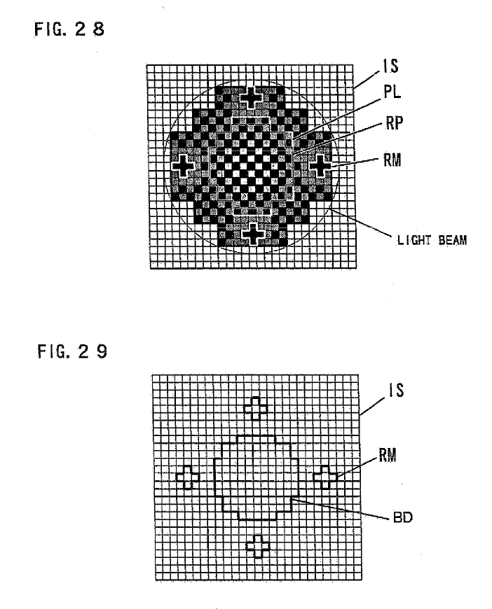

Then, the control circuit compares the stored contour line PL with stored patterns (step S6). The control circuit selects a stored pattern RP completely enclosed in the pattern of the candidate contour line PL, for example as shown in FIG. 28.

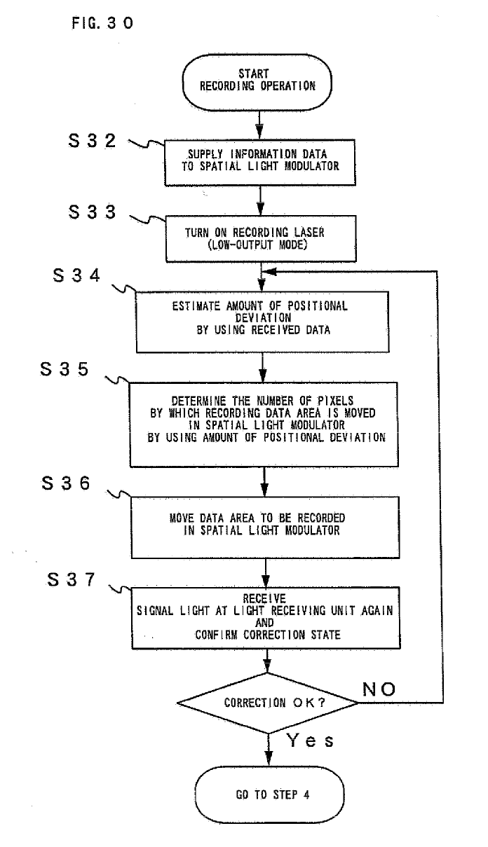

Next, as shown in FIG. 29, the multilevel recording area (the first boundary BD in the spatial light modulator) is determined, and the recording operation corresponding to the multilevel recording area is initiated (step S7).

The step S3 in which the pattern matching is performed is carried out, for example, by following the flowchart shown in FIG. 30.

After the reproduction of the test pattern is initiated and the position of the objective lens is determined, information data containing positioning mark data is supplied to the spatial light modulator (step S32). Then, a low-output laser beam is applied to the spatial light modulator to generate spatially modulated signal light (step S33). It is noted that a shutter (not shown) may be provided in the light path of the reference light and only the signal light may be applied onto the recording medium until the position of the multilevel modulation area is determined relative to the range of the aperture area of the objective lens, and then the signal light and the reference light may be applied in the recording step.

Such signal light is applied onto the recording medium through the objective lens, and the image sensor IS receives the signal light from the recording medium to obtain optically received data. Then, the position where the positioning mark data contained in the optically received data is detected is used to estimate the amount of positional deviation between the optical axis of the objective lens and the optical axis of the signal light, that is, the amount of positional deviation in units of pixels (ΔPx, ΔPy) on the image sensor IS (step S34).

The amount of positional deviation on the image sensor IS is used to determine the amount of displacement in units of pixels (Δpx, Δpy) by which the modulation area should be displaced in the spatial light modulator. The amount of displacement in units of pixels (Δpx, Δpy) is determined by using the number of oversampling, i.e., “n” which is the number of groups of light receiving elements in the X and Y directions that detect unit data of page data. That is, the calculation is carried out using the following equation:

Δpx/n=Δpx,Δpy/n=Δpy (step S35).

Based on the amount of displacement in units of pixels (Δpx, Δpy) described above, the position of the multilevel modulation area in the spatial light modulator is moved and positioned (step S36).

Upon the positioning, the spatial light modulator is irradiated with the laser light to generate signal light, and the recording medium is irradiated again with the signal light through the objective lens. The signal light from the recording medium is detected to check whether or not the multilevel modulation area is aligned with relative to the aperture area of the objective lens (step S37).

When the positioning is not completed, the process returns to the step S34 for determining the amount of positional deviation in units of pixels (ΔPx, ΔPy) on the image sensor IS, and the steps for correcting the position of the multilevel modulation area in the spatial light modulator are repeated again.

On the other hand, when the positioning is completed, the process proceeds to the step S4 for measuring the contrast distribution with reference to the positioning marks.

Furthermore, the method for determining the amount of optical positional deviation between the aperture area of the objective lens and the multilevel modulation area is not limited to detecting the positioning marks as described above. For example, the peak position of the light magnitude distribution of the signal light on the light receiving plane where the light receiving elements of the image sensor IS are disposed may be determined, and the amount of deviation between the reference position of the image sensor IS and the peak position is used to position the multilevel modulation area in the spatial light modulator. It is noted that the light magnitude distribution is the distribution of the integral values of the area, in the direction of one of two axes that form the light receiving surface, where the signal light passes through in the other axial direction.

It is noted that in the positioning step, the information data supplied to the multilevel modulation area may not contain data to be recorded. In such a case, it is preferable to supply the spatial light modulator with information data in which the peak of the light magnitude distribution on the image sensor IS becomes the center position of the objective lens independent of the displacement of the objective lens. That is, the information data preferably forms page data in which the modulation/non-modulation distribution is uniform in the two-dimensional plane of the spatial light modulator. Examples of the information data include a checker pattern in the whole space above the spatial light modulator and page data that transmit incident light in the whole space above the spatial light modulator (that is, all white).

### [Other Methods for Recording Holograms]

Furthermore, in the step S4 for measuring the contrast distribution, although the measurement is carried out by irradiating a test pattern containing positioning marks, it is also possible to carry out the measurement by irradiating full-white and full-black patterns. In this case, in the initial operation, upon the start thereof, the XYZ-direction servo and the spindle servo are carried out as in the step S1. Since no recording is performed on the recording medium, the full-white and full-black patterns are alternately applied onto an area having no recording layer but the reflective layer, and the contrast distribution is measured through calculation based on the optically received data from the image sensor (step S20 instead of S4). Then, as in the above recording method, the following steps are carried out: a candidate for the multilevel recording area is determined based on the contrast distribution (step S5); the candidate for the multilevel recording area is compared with stored patterns (step S6); and the multilevel recording area is determined and the recording operation corresponding to the multilevel recording area is initiated (step S7).

1. A hologram recording and reproducing apparatus for a hologram recording medium that stores optical interference fringes therein as a diffraction grating generated by coherent reference light and signal light, the apparatus comprising:
a light source that generates coherent reference light;
a spatial light modulator disposed on the optical axis of the reference light, the spatial light modulator having a plurality of pixels and using the plurality of pixels to modulate the reference light into signal light;
an interference section that applies the signal light and the reference light onto the hologram recording medium to form a hologram area therein using optical interference fringes generated by the signal light and the reference light; and
an image sensor that receives the reference light or reproduced light generated by the reference light and originating from the hologram area,
wherein the apparatus further comprises a control circuit that is connected to the spatial light modulator and the image sensor and controls each of the pixels in such a way that the reference light is modulated according to information data to produce the signal light, and
wherein the control circuit spatially classifies the plurality of pixels into a central modulation area disposed on the optical axis and at least one annular modulation area sequentially disposed around the central modulation area in a concentric manner, and controls the pixels in the central modulation area and the pixels in the annular modulation area using respective different recording modulation methods to deliver the signal light through the central modulation area and the annular modulation area.

2. A hologram recording and reproducing apparatus as according to claim 1, wherein the control circuit uses the image sensor that receives the reference light or reproduced light generated by the reference light and originating from the hologram area to measure light intensity distribution.

3. A hologram recording and reproducing apparatus according to claim 1, wherein the control circuit defines the boundary between the central modulation area and the annular modulation area based on the measured light intensity distribution.

4. A hologram recording and reproducing apparatus according to claim 1, wherein the control circuit determines the recording modulation methods for the central modulation area and the annular modulation area based on the measured light intensity distribution.

5. A hologram recording and reproducing apparatus according to claim 1, wherein the central modulation area and the annular modulation area are classified into an inner multilevel modulation area in which the light intensity of the reference light is modulated for each of the pixels using three or more levels; and an outer multilevel modulation area in which the light intensity of the reference light is modulated for each of the pixels using the number of levels fewer than that used in the central modulation area, an outer two-level modulation area, or an outer non-modulation area.

6. A hologram recording and reproducing apparatus according to claim 5, wherein the pixels are controlled in such a way that light intensity modulation is performed in each of the central modulation area and the annular modulation area sequentially disposed from the inner side, using the three or more levels for the central modulation area and decremented grayscale for the following annular multilevel modulation area.

7. A hologram recording and reproducing apparatus according to claim 1, wherein each of the pixels in the central modulation area and the annular modulation area is controlled using a light intensity modulation method in which the amount of light that the image sensor receives increases as the pixel is closer to the inner side or farther from the outer side.

8. A hologram recording and reproducing apparatus according to claim 1, wherein each of the pixels in the central modulation-area and the annular modulation area is controlled using a light intensity modulation method in which the amount of light that the image sensor receives decreases as the pixel is closer to the inner side or farther from the outer side.

9. A hologram recording and reproducing apparatus according to claim 1, wherein each of the pixels in the central modulation area and the annular modulation area is controlled using a light intensity modulation method in which the resolution for the pattern formed of each of the pixels increases as the pixel is closer to the inner side or farther from the outer side.

10. A hologram recording and reproducing apparatus according to claim 1, wherein the apparatus farther comprises positioning means for positioning the central modulation area and the annular modulation area by detecting the amount of optical positional deviation between the central modulation area and the annular modulation area in the spatial light modulator and the aperture area of the objective lens.

11. A hologram recording and reproducing apparatus according to claim 10, wherein the positioning means includes means for determining the amount of relative, optical positional deviation between the central modulation area and the annular modulation area in the spatial light modulator and the range of the aperture area using data optically received from the reproduced light detected by the image sensor.

12. A hologram recording and reproducing apparatus according to claim 11, wherein the means for determining the amount of optical positional deviation incorporates positioning mark data into the information data and determines the amount of positional deviation based on the positioning mark data contained in the optically received data.

13. A hologram recording and reproducing apparatus according to claim 11, wherein the means for determining the amount of optical positional deviation uses the optically received data to determine the amount of positional deviation based on the peak position of the return light beam magnitude distribution on the image sensor.

14. A hologram recording method used in a hologram recording and reproducing apparatus including a spatial light modulator disposed on the optical axis of coherent reference light, the spatial light modulator having a plurality of pixels and using the plurality of pixels to modulate the reference light into signal light, an interference section that applies the signal light and the reference light onto a hologram recording medium to form a hologram area therein using optical interference fringes generated by the signal light and the reference light, and an image sensor that receives the reference light or reproduced light generated by the reference light and originating from the hologram area, the method comprising the steps of:
measuring light intensity distribution by using the image sensor that receives the reference light or reproduced light generated by the reference light and originating from the hologram area;
based on the measured light intensity distribution, spatially classifying the plurality of pixels into a central modulation area disposed on the optical axis and at least one annular modulation area sequentially disposed around the central modulation area in a concentric manner; and
controlling the pixels in the central modulation area and the pixels in the annular modulation area using respective different recording modulation methods.

15. A hologram recording method according to claim 14, wherein the method further comprises the steps of:
measuring a contrast value based on the measured light intensity distribution; and
determining the boundary between the central modulation area and the annular modulation area based on the contrast value and a predetermined threshold value.

16. A hologram recording method according to claim 15, wherein in the step of measuring the contrast value, a test pattern containing positioning marks is applied and recorded onto the hologram recording medium, and a reproduced image of the test pattern is used to obtain the contract value.

17. A hologram recording method according to claim 15, wherein the step of measuring the contrast value, full-white and full-black patterns are applied onto the image sensor without using the hologram recording medium, and the contrast value is obtained through calculation based on the optically received data from the image sensor.

18. A hologram recording method according to claim 14, wherein the central modulation area and the annular modulation area are classified into an inner multilevel modulation area in which the light intensity of the reference light is modulated for each of the pixels using three or more levels; and an outer multilevel modulation area in which the light intensity of the reference light is modulated for each of the pixels using the number of levels fewer than that used in the central modulation area, an outer two-level modulation area, or an outer non-modulation area.

19. A hologram recording method according to claim 18, wherein the pixels are controlled in such a way that light intensity modulation is performed in each of the central modulation area and the annular modulation area sequentially disposed from the inner side, using the three or more levels for the central modulation area and decremented grayscale for the following annular multilevel modulation area.

20. A hologram recording method according to claim 14, wherein each of the pixels in the central modulation area and the annular modulation area is controlled using a light intensity modulation method in which the amount of light that the image sensor receives decreases as the pixels closer to the inner side or farther from the outer side.

21. A hologram recording method according to claim 14, wherein each of the pixels in the central modulation area and the annular modulation area is controlled using a light intensity modulation method in which the amount of light that the image sensor receives increases as the pixel is closer to the inner side or farther from the outer side.

22. A hologram recording method according to claim 14, wherein each of the pixels in the central modulation area and the annular modulation area is controlled using a light intensity modulation method in which the resolution for the pattern formed of each of the pixels increases as the pixel is closer to the inner side or farther from the outer side.
